(19) United States
(12) Patent Application Publication
(10) Pub. No.: US 2010/0114674 A1
(43) Pub. Date: May 6, 2010

(54) Auditable method and system for generating a verifiable vote record that is suitable for electronic voting

(75) Inventors: Vanesa Daza Fernandez, Sant Cugat Del Valles (ES); Jorge Puiggali Allepuz, Sant Cugat Del Valles (ES); Andreu Riera Jorba, Sant Pedor (ES); Andreu Riera Alonso, Barcelona (ES); Pere Valles Fontanals, Barcelona (ES)

Correspondence Address: RATNERPRESTIA, P.O. BOX 980, VALLEY FORGE, PA, 19482, US

(73) Assignee: SCYTL SECURE ELECTRONIC VOTING, S.A., Barcelona (ES)

(21) Appl. No.: 11/912,760

(22) PCT Filed: Apr. 26, 2005
(86) PCT No.: PCT/ES05/00215

§ 371 Date: Oct. 21, 2009

(30) Foreign Application Priority Data
Apr. 26, 2005 (ES) PCT/ES2005/000215

(51) Int. Cl. G07C 13/00

(52) U.S. Cl. 705/12; 235/386

(57) ABSTRACT

The invention relates to an auditable method and system for generating a verifiable vote record that is suitable for electronic voting. The inventive method is characterized in that a voting module, an audit module and a verification module perform the following steps in which: voting options are selected by the voter in the voting module; the voting options are sent from the voting module to the audit module; a vote record is generated in the verification module which contains the voting options selected by the voters in the voting module; the voter confirms that the vote record contains the voting options that s/he selected in the voting module by direct verification of the vote record; and audit information is generated in the audit module in order to secure the electronic vote and/or the associated vote record which are both generated from the voting options selected and confirmed by the voter.

### FIELD OF THE INVENTION

This invention is essentially comprised within the field of electronic voting and introduces an auditable method for generating a voter verifiable vote record, by means of using cryptographic protocols. The method provides audit information, which allows assuring certain necessary properties in a voting process, such as the integrity of said vote record, its authenticity or the non-repudiation, preventing the addition of bogus votes or the modification of votes which have been correctly cast.

As is known in the state of the art, the mentioned vote record is generated in a verification module, such as a printer, from one or more voting options selected by the voter in a voting module, such as a DRE. The purpose of said vote record is to enable the voter to directly verify that the options of the printed vote record coincide with the options previously selected by the voter in the voting module. The generation of a vote record for each cast vote allows a parallel audit of the electoral process.

The invention also relates to an audit module that is easily auditable for implementing the proposed method. This module is intercalated between the voting module and the verification module.

### BACKGROUND OF THE INVENTION

In an electronic voting method, a voter or a plurality of voters cast their votes from an electronic device, which is usually referred to as the voting terminal. The voter selects in said voting terminal all or part of the voting options and verifies in the voting terminal that said selected options reflect his/her voting intention. After confirming that said options coincide with his/her voting intention, she/he will then cast the vote, which will be electronically stored to enable its later recount. To assure that an election is carried out accordingly, it is important for the vote to be correctly stored (i.e. as it was cast by the voter) and for the counting processes to be carried out using the stored votes. It is therefore important that the electronic voting terminals have measures assuring these properties.

The first electronic voting machines, known as DRE (Direct Recording Electronic), were introduced in the United States in the 1970s (U.S. Pat. No. 3,934,793B1). In these machines, the voter casts his/her vote in the voting terminal in which, after confirming that the selected options reflect his/her voting options, the cast votes are recorded and stored electronically in the DRE.

The main problem with these terminals is that they do not provide an independent and parallel vote record in which the voter can verify if his/her voting options have been recorded correctly before casting the vote. Errors in the record of selected voting options could thus be detected before the votes were cast. Most of the irregularities detected today, such as a voting ballot box containing more votes than voters, could thus be prevented. This parallel record can additionally be used in the event of problems for performing a parallel recount.

Another problem is the lack of adequate measures for protecting the stored votes. In many cases, the protective measures that are used are insufficient and put the integrity of the votes, and accordingly the honesty of the election, at risk.

Another problem with this type of terminals is the difficulty of auditing them. Most electronic voting terminals existing on the market are complex devices with a combination of hardware and software architecture, and they are generally protected by intellectual property rights or use components (e.g. software) that are subject to these rights. This all causes little transparency as to how the electoral process is internally carried out in voting terminals and, accordingly, increases the uncertainty of a possible manipulation of the votes cast from the voting terminal. The auditing processes intended for verifying compliance with the security election requirements and detecting possible fraudulent practices, are furthermore generally expensive and rather non-transparent. In fact, they are generally done in independent laboratories that must sign very strict confidentiality agreements. These are some of the main reasons that there are still many skeptics in relation to the use of said electronic voting terminals.

Some studies reported the lack of verification of the correct vote recording, the insufficient measures for protecting the cast votes and the auditing difficulties. For example, the commonly named Hopkins Report (Khono T., Stubblefield A. and Rubin A. Analysis of an Electronic Voting System. Johns Hopkins Information Security Institute Technical Report TR-2003-19) published in July 2003 and which questioned the security of one of the largest DRE manufacturers in the United States. In addition to this report there are other ones, such as the analysis of the security of electronic voting machines conducted by the commission on electronic voting of Ireland (First Report of the Commission on Electronic Voting on the Secrecy, Accuracy and Testing of the Chosen Electronic Voting System), which confirms the security problems of the electronic voting machines (DRE-type) used in the electoral processes in Ireland.

As a result, different proposals are made in this field with the main objective of mitigating this lack of security and auditability in electoral processes based on DREs. These proposals allow assuring to a certain extent that the electronic voting machine accurately records votes cast by the voters and preserves the integrity and privacy of said votes.

A first group of proposals is based on the use of cryptographic protocols for protecting the votes and for enabling the audit of the election. These proposals, such as those described in EP-B1-1 224 767, WO-A3-02/077754, WO-A2-03/071491, WO-A1-03/050771 and the patent application PCT/ES04/000350, assure the correct development of the electoral process by means of cryptographically protecting the digital votes cast and generating a verifiable record for the voter. This verifiable record is based on a vote receipt, generated by means of cryptographic techniques, which the voter can use to verify that his/her vote, has been considered in the final count after the election is finished This receipt does not disclose any of the voting options selected by the voter, thus preventing problems such as coercion or vote buying (sale of votes). The main drawback of these cryptographic proposals is that said receipt cannot be used in a parallel recount, since it does not contain the selected voting options. In addition, the verification of the correct recording of the voting options selected in the voting terminal, using the vote receipt could be a process difficult to understand for the voter. Therefore, the voter must be confident that this process is secure.

There is a second group of solutions based on generating a paper printout of the vote, i.e. printing the voting options selected by the voter. Therefore, this provides a paper parallel record of the electronic vote stored in the voting terminal. This paper vote allows the voter to visually verify the content of the vote before being cast. Since the printed vote contains the voting options selected by the voter, this allows the implementation of a parallel recount of the votes if requested, facilitating an audit of the final results.

The first solution based on the printout of paper votes was introduced by Dr. Mercuri at the beginning of the 1990s (Mercuri, R. Facts About Voter Verified Paper Ballots). This solution, also known as the Mercuri method, requires the protection of the printed vote from any voter manipulation by means of putting a transparent surface (glass or viewer) in front the printout. The correctness of the vote is then examined by the voter through this glass or viewer. Therefore, the voter cannot accidentally or purposely manipulate the printed vote. Finally, if the voter accepts the printed vote, this vote is automatically deposited in a ballot box without the voter participation. In the event that the voter does not accept it, the printed vote must be destroyed or marked as invalid before being automatically deposited in the ballot box. One of the main problems with this method is that it does not allow voters with visual disabilities to verify the vote, since the method only allows a visual verification of the printed vote. In addition, it is not clear what happens in case of a voting terminal failure, such as the introduction of a rejected printed vote in the ballot box without being invalidated. Another problem is that the ballot box protects the integrity of the printed vote against voter manipulation, but it does not guarantee the integrity of the paper vote once it has been cast. In other words, it does not prevent the addition, substitution or elimination of votes in the ballot box by third parties with access privileges to the ballot box. Furthermore, it is an expensive and difficult to manage solution since it requires the addition of a specific ballot box and printer per voting terminal.

For the purpose of speeding up the counting process, there are other paper printout based solutions which do not require the protection of the printed paper vote from the voter. This group includes solutions such as those proposed in US2003/006282-A1, US 2004/0195323-A1 or the Keller A. M. et al. publication, A PC-Based Open Source Voting Machine with an Accessible Voter Verifiable Paper Ballot. Unlike the Mercuri solution, these ones make use of special codes or inks to protect the integrity of the vote when it is printed out. This prevents the recount of votes that have not been generated by valid terminals. In this group, the vote is electronically stored after confirmed and the voter must deposit the printed vote in the corresponding physical ballot box. The main problem with these solutions is that do not guarantee a coherent record of the electronic votes and the paper votes, since it cannot guarantee that the voter deposits the paper vote in the ballot box after casting a vote in the voting terminal. This approach generates more voter confidence in the printed paper vote than in the electronic vote. However, since the voter has access to a printed paper vote containing the selected voting options, fraudulent practices such as coercion or the vote buying are facilitated. Furthermore, even though special codes or inks are used to assure the integrity and/or authenticity of the vote, these marks cannot be verified by the voters without electronic means. Therefore, a malfunction or manipulation of the voting terminal could allow invalidating valid votes verified and cast by the voter without the voter knowledge.

It is therefore necessary to introduce a new method for generating a vote record verifiable by the voter, which enables the manual audit and recount of said record, which can be used independently by persons with visual disabilities and which protects the integrity of said record, without facilitating its invalidation due to errors or manipulations.

### BRIEF SUMMARY OF THE INVENTION

This invention describes an easily auditable method for the generation 203 of a vote record 104 explicitly containing the voting options selected by said voter 106 in a voting module 101. This vote record 104 can further be used for performing a parallel recount of the votes cast. The invention also relates to the features of an audit module 103 associated to a voting module 101 and a verification module 102, forming an electronic voting system that enables implementing said method.

Therefore, a first objective of this invention is to define a secure method for generating a vote record 104 enabling voters 106 the direct verification of said vote record 104, as it is going to be stored.

It is also an objective of the invention enabling the voter 106 to invalidate the vote record 104 when does not contain the voting intention, preventing the confusion of said record with a valid record one when invalidated. This invalidation must not prevent the voter 106 from returning to the selection process 201 and confirmation process 204 again for finally casting a valid vote.

Another objective of this invention is to allow the direct use of the same vote record 104 in a manual or mechanical recount. A manual recount is being understood as a non-mechanized process carried out by persons who need not have technical skills.

For the purpose of protecting the integrity, authenticity and non-repudiation of the cast vote record, another objective of the method is to generate a mark which enables the verification of the vote record 104 integrity once it is confirmed. This mark will allow the verification that the vote has been cast from a valid device and has not been manipulated once confirmed by the voter 106.

Another objective of this invention is to prevent isolated errors or intentional manipulations in the voting module 101 and/or in the audit module 103 from invalidating the vote record or electronic votes.

Another objective of this invention is to provide a mechanism which reduces the auditing effort of the electronic voting systems by focusing said audit process exclusively on the audit module 103.

This invention also allows protecting the integrity of the electronic votes stored in the voting module 101, facilitating the detection of inconsistencies in the event that the recount of the vote record does not coincide with the record of said electronic votes.

Finally, but no less important, it is also an objective of this invention to not limit its field of application to electronic voting environments. Therefore it is also considered the use of the described method to protect, for example, the record integrity of any relevant electronic documents.

The proposed method is characterized by comprising the following basic steps: receiving in an audit module 103 a digital information containing voting options selected in a voting module 101; generating in a verification module 102 a vote record 104 verifiable by the voter 106 containing the voting options selected by the voter 106 received by the audit module 103; confirming if the vote record 104 contains the voting options selected by the voter 106 in the voting module 101; and generating in the audit module 103, if the vote record is confirmed, information which enables verifying the validity of the vote record 104.

Furthermore, the proposed method enables the use of more than one additional verification module 102 to provide different alternative verification methods for visual impaired persons.

In the event that the voter 106 rejects the vote record 104 (e.g., does not contain his/her voting intention), the method allows permanently invalidating said record in a way that prevents any confusion with a valid record.

It is also considered a possibility that each vote has a unique identifier that can be generated in a cooperative manner between the voting and audit modules mentioned.

The proposed method comprises additional steps enabling the collaborative generation 205 of an audit record between the voting module 101 and the audit module 103 to prevent a single point of failure that could invalidate said vote record 104.

The proposed method also considers the implementation of optional steps which enable keeping synchronized the vote record with the electronic votes stored in the voting terminal, thus facilitating a subsequent audit.

The most basic version of the audit module 103 used for implementing the proposed method comprises the following elements: input and output means to receive and send digital information related to the voting options selected by the voter 106 in the voting module 101, and processing means which enable generating digital audit information 105 to assure the integrity, the authenticity and the non-repudiation of the votes cast and to detect possible issues (voluntary or involuntary) of the protocol executed in the voting module 101.

Said audit module 103 further comprises in a preferred alternative implementation storage means which enable it to store audit information.

Other features of the invention, and more concretely the particular features of the steps of the method and elements forming the audit module 103, will be described in greater detail below and illustrated with sheets of drawings.

### BRIEF DESCRIPTION OF THE DRAWINGS

FIG. 1 shows in a simplified manner the main elements for implementing the method described in this invention: a voting module 101 through which the voter 106 carries out a selection 201 of voting options; a verification module 102 which generates a vote record 104 containing the selected voting options in the voting module 101 that can be verified by voter 106; and an audit module 103 which receives the voting options sent 202 by the voting module 101, sends said voting options to the verification module 102 to generate the vote record 104, and generates, after a voter 106 confirmation 204 by action or omission, an audit information 105 that guarantees the validity of at least the vote record 104, using at least the voting options selected by the voter 106 in the voting module 101.

FIG. 2 schematically shows the basic steps performed by the method proposed in this invention. After carrying out a step of selecting 201 voting options in the voting module 101, this voting module 101 carries out a step of sending 202 the voting options to an audit module 103. This audit module 103 sends the voting options to the verification module 102 to carry out a step of generating 203 a vote record 104 verifiable by the voter 106. Finally, after a step of confirmation 204 of the vote record 104 contents by the action or omission of the voter 106, a step of generating 205 audit information 105 is implemented by the audit module 103 using at least the voting options.

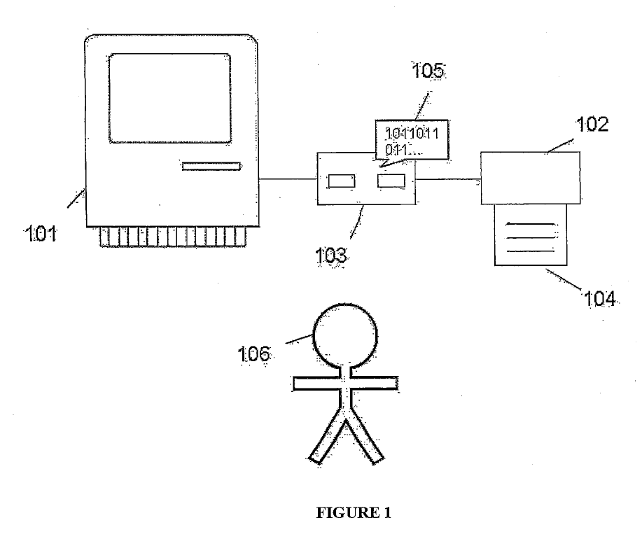

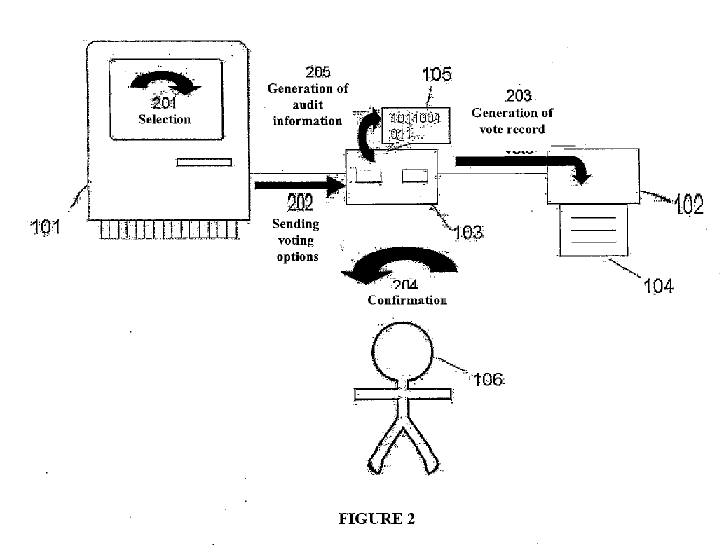

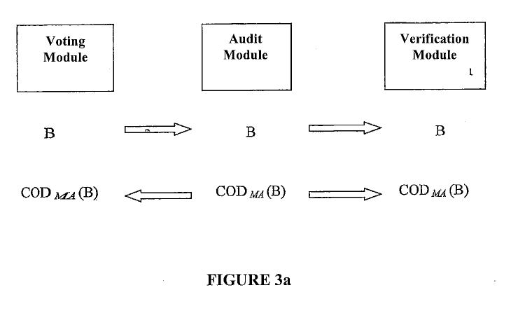

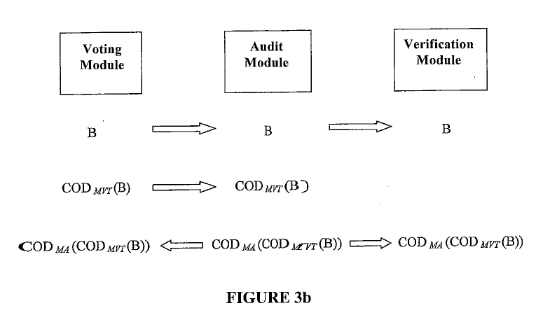

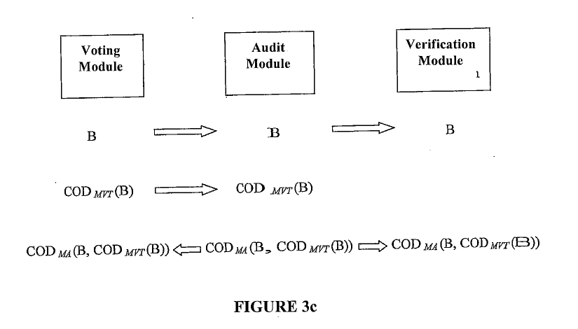

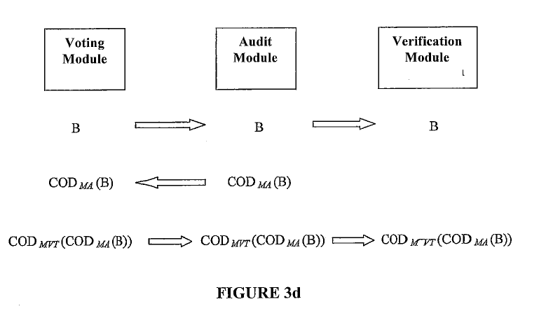

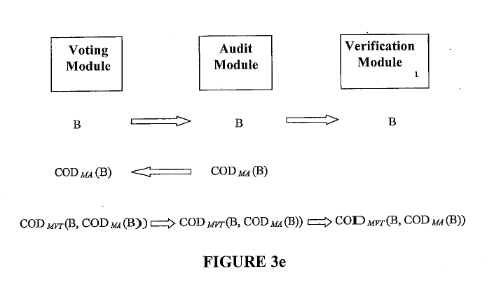

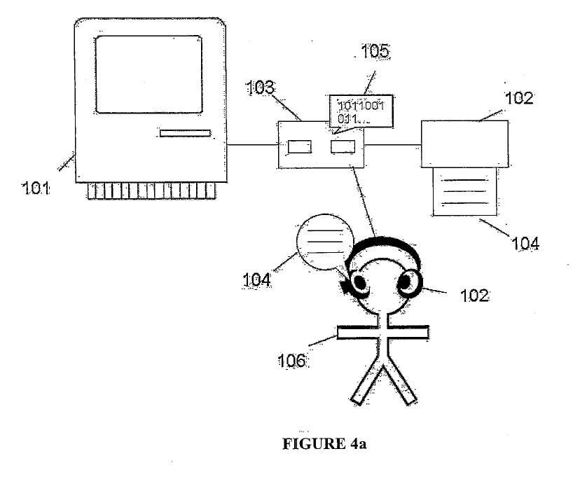

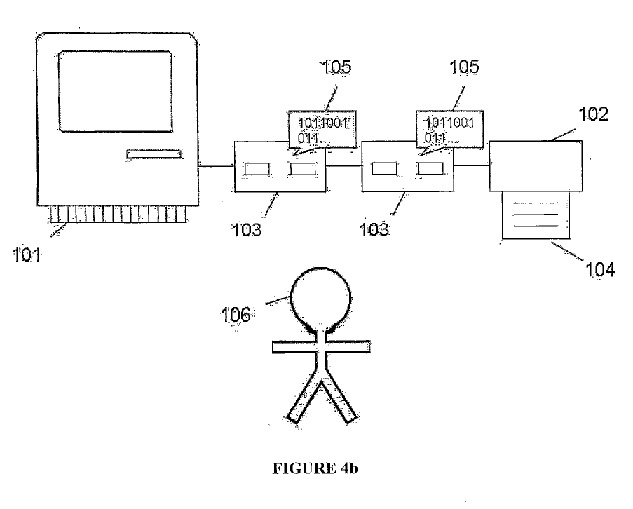

FIGS. 3a, 3b, 3c, 3d and 3e describe different approaches for the generation 205 of audit information 105 using different encoding techniques. The following notation will be used to facilitate a more detailed description of the listed cryptographic process and protocols:
B: Information containing the voting options selected by the voter 106 in the voting module 101. It could also contain other additional information such as a single vote identifier.
COD_{MA} (B): Encoding of information B by means of a key MA associated to the audit module 103.
COD_{MVT} (B): Encoding of information B by means of a key MVT associated to the voting module 101.
COD_{MA} (COD_{MVT} (B)): Encoding by means of a key MA associated to the audit module 103, of an information B previously encoded by means of a key MVT associated to the voting module 101.
COD_{MA} (B, COD_{MVT} (B)): Encoding by means of a key MA associated to the audit module 103, of an information B with the same information B but previously encoded by means of a key MVT associated to the voting module 101.

FIG. 3a shows an approach in which the audit information 105 is generated 205 only by means of the audit module 103. However, in FIGS. 3b, 3c, 3d and 3e this generation 205 is carried out in a cooperative manner by means of the audit module 103 and the voting module 101. The figures start with common steps of sending 202 to the audit module 103 and the verification module 102, an information B containing the voting options selected by the voter 106. Then, after a step of confirmation, each figure differs showing different approaches of generation 205 of audit information 105. Commonly in all Figures again, this audit information 105 is finally sent to the verification module 102 which can add it to the vote record. This audit information 105 is also sent to the voting module in case it was not previously available, so that it can add it to an electronic vote.

FIG. 3a shows an approach in which the audit information 105 is generated in the audit module 103 by means of a encoding the information B with a key MA assigned to said audit module 103. FIGS. 3b and 3d show two approaches in which the audit information 105 is generated by means of a second encoding of previously encoded information B. In FIG. 3b, the first encoding is carried out in the voting module 101 and the second encoding is carried out in the audit module 103. The encoding order is reversed in FIG. 3d, the first encoding is thus carried out in the audit module 103 whereas the second encoding is carried out in the voting module 101. FIGS. 3c and 3e finally show two approaches similar to the last two approaches set forth, but in which the audit information 105 is generated by means of a second encoding based on information B and a first encoding of said information B. In approach 3c, the first encoding is carried out in the voting module 101 and the second encoding is carried out in the audit module 103, whereas in FIG. 3e the first encoding is carried out in the audit module 103 and the second is carried out in the voting module.

FIGS. 4a and 4b finally show two possible implementations of the described method in which some of the modules are duplicated. FIG. 4a shows an implementation using two audit modules to facilitate a dual verification, using visual and audible means. In implementation 4b, more than one audit module 103 are connected to one another to generate audit information 105 in a cooperative manner therebetween is used.

### DETAILED DESCRIPTION OF THE INVENTION

This invention relates to a method and a system applicable to an electronic voting environment to facilitate the audit and protection of electoral processes using an electronic voting module 101, such as a DRE (Direct Recording Electronic) for selecting 201 votes and a verification module 102, such as a printer, for generating 203 a voter 106 verifiable vote record 104. The scope of the invention does not cover tasks such as compiling the electoral roll, the registration of voters 106, the recount of the votes cast during the electoral process, or the possible management of the keys of voters 106.

In this invention, vote will be understood as any record, either digital or non-digital, cast by an eligible voter 106. A vote will generally consist of different questions containing different voting options which the voter 106 must select. It will be assumed in the following explanations, without losing generality, that a single question will be asked in each vote. In the event that this is not so, the method can be applied both individually and jointly in the total of the questions forming the vote. It must be observed that when digital information or a vote record 104 containing the voting options selected by the voter 106 is mentioned herein, it is understood that said information or record contains a representation in any of the different possible formats supported by said voting options.

The use of an audit module 103 is proposed to put this invention into practice. This audit module 103 is associated to the corresponding voting module 101 and to the verification module 102. Although the three modules can be grouped individually or jointly, in a preferred implementation the audit module 103 is intercalated between the voting module 101 and the verification module 102. Among the main contributions of this audit module 103, it is emphasized: the generation 205 of digital audit information 105 for security protecting the process of generating 203 the vote record 104, and the complexity reduction of the process for auditing the votes.

The audit module 103 receives from the voting module 101 information containing the voting options selected by the voter 106 and these received voting options are sent by this audit module 103 to the verification module 102. Based on the voting options, the verification module 102 generates a vote record 104 verifiable by the voter 106 which must explicitly contain the received voting options. The voter 106, by action or omission, must confirm if the vote record 104 contains his or her voting intention. Once the confirmation has been received, the audit module 103 will generate audit information 105 providing several properties to the vote record 104 generated by the verification module 102 such as the integrity, the authenticity and the non-repudiation.

According to this invention, in a basic implementation the audit module 103 comprises the elements described below. An input and output unit which allows receiving and sending 202 information in digital format related to the voting options selected by the voter 106 in the associated voting module 101. And processing means allowing generate certain digital audit information 105 facilitating the audit of the electoral process, and allowing generating a secure vote record.

In a preferred implementation, said audit module 103 also incorporates confirmation means to allow the voter 106 to confirm if the voting options recorded in the vote record 104 are the desired options or not.

The provision of storage means to said audit module 103 has also been considered. This storage means has the capacity to store digital information related to the voting options or, in the event that it is necessary, to store the necessary cryptographic keys to carry out the cryptographic protocols described below. Due to the fact that the data stored in said storage unit can be needed during the election, this storage unit must be persistent, thus preventing the possibility of a data loss generated by an electric power failure, for example. This invention also considers that part of the processing means and of the storage means of the audit module 103 are located in a removable device containing said means, such as a cryptographic smart card. The security measures and the correct operation of said module would thus be improved.

To facilitate the integration with a voting module 101, the audit module 103 can have an independent power supply. It can thus obtain power for its operation from an own energy cell or being directly connected to the mains supply. It has also been considered that said power is obtained from the voting module 101 to which it is associated.

The invention involves that the voting module 101 essentially has a display interface for showing the voting options that the voter 106 should select, and means with which the voter 106 interacts to carry out a step of selecting 201 one or more voting options. The invention considers the possibility of an implementation in which the voting module 101 has storage means for, storing the selected voting options after the selection step. Therefore, such stored selected options can be provided later to a local or remote processing site to count them. It is also considered the possibility that said storage means store the necessary information (such as keys, for example) required to implement the cryptographic protocols which will be detailed below. As has been described for the case of the audit module 103, it is also considered the possibility that part of the processing means and of the storage means of the voting module 101 are grouped into a removable device containing said means, such as a cryptographic smart card.

As regards the verification module 102 the invention assumes that it is essentially composed by input and output means, whereby the verification module 102 can be connected to the audit module 103. To facilitate the accessibility of voters 106 with disabilities, this invention considers the use of different verification modules which will allow generating different types of vote record 104. For this purpose, it is considered the possibility that said vote record 104 can be visual or auditory, for example. Finally, it is also considered the possibility of more than one verification module 102 connected to an audit module 103 to allow the voters 106 to use different forms of verifying the same voting options.

As mentioned above, in this invention an easily auditable method is set forth in which a voting module 101, a verification module 102 and an audit module 103, provide a verifiable vote record 104. The mentioned method is essentially characterized in that after a step of selecting 201 the voting options in the voting module 101, the following three basic steps are implemented using the three modules which have just been mentioned:

receiving in the audit module 103 digital information sent 202 by the voting module 101 containing the voting options previously selected by the voter 106 in said voting module 101;

sending from the audit module 103 to the verification module 102 at least the voting options received from the voting module 101 from which the verification module 102 generates a vote record 104. To facilitate the verification by the voter 106 of the vote record 104, said vote record 104 explicitly contains at least the voting options selected by said voter 106 in the voting module 101.

confirming, by means of action or omission, if the voter 106 agrees with the voting options contained in the vote record 104.

generating by means of the audit module 103 digital audit information 105 related to the voting options selected by the voter 106 in the voting module 101. This digital information will allow to verify the validity of the votes cast in an audit of the electoral process.

This method considers an additional step in which, once the vote record 104 has been confirmed, the voting module 101 internally stores a vote in electronic format with the voting options that the voter 106 has confirmed. This electronic vote can also contain the result of the confirmation 204 of the voter indicating that it was an accepted (suitable for the recount) or rejected (not suitable for the recount) vote. A rejected vote is that which does not include the voting intention of the voter 106 and therefore, it cannot be counted. A vote can be rejected due a change of opinion of the voter 106 or an error while selecting 201 the options, detected when verifying the vote record 104. In that case, the voter 106 has the option of returning to the step of selecting 201 the voting options to modify them. Since the vote record 104 that contains the voting intention of the voter 106 has been rejected, it is important that the electronic vote related to said record reflects this rejection to prevent it from being counted. Furthermore, when the vote record is rejected, it is considered the possibility that said electronic vote is not finally stored.

The method considers that the vote record 104 verifiable by the voter 106 can be in different formats to facilitate the verification for voters 106 with disabilities. For example, if a visual verification is to be provided to the voter 106, the vote record 104 is provided by means of a printer. In case an auditory verification is provided to the voter 106, its implementation is done through an audio device, such as headphones. It is also considered the possibility that different verifications can be carried out simultaneously, for example audibly and visually using two different verification modules connected to the same audit module 103.

To improve the security and auditability of the method, it is also provided the possibility that the confirmation means are located in the audit module 103. In this case the audit module 103 generates digital confirmation information containing mainly the confirmation 204 of the voter 106, to communicate said confirmation 204 to the voting module 101 and/or to the verification module 102. The method of this invention especially considers the possibility that the confirmation of the voter 106 is negative (i.e., a rejection). In other words, that the voter 106 considers that the options of the vote record 104 do not coincide with the voting options which he or she has selected previously or which he or she really wanted to select in the voting module 101. In this case said digital confirmation information can additionally contain encoded digital information based on the voting options selected by the voter 106 in the voting module 101 and/or the confirmation meaning of the voter 106. As an auditing measure, the confirmation information can also be sent to the verification module 102 for adding it to the vote record 104 and therefore, stating if the vote record 104 has been accepted or not by the voter 106. It is also considered the option that the confirmation information is used by the audit module 103 for generating the audit information 105.

For the step of confirmation, the method described in this invention considers the use of confirmation means allowing the voter 106 to carry out said confirmation, if he or she considers this necessary. In the step of confirmation 204, there may be a default option which is automatically carried out if certain conditions are fulfilled. For example, the automatic confirmation 204 of the voting options after an established inactivity time period after the generation 203 of the vote record 104. Therefore, the privacy of the voter 106 is thus protected or a voter 106 is prevented from voting more than once if the previous voter forgot to confirm the vote. A basic implementation would consist only of a confirmation button, being able to be extended to more buttons in the event that it is considered suitable. To facilitate the accessibility of voters 106 with visual disabilities, an alternative embodiment considers the confirmation by replying to at least two audible orders, this confirmation carried out from a microphone available for the voter 106.

For the purpose of improving the auditability of the election and protecting the vote record 104 generated by the voting module 101, this invention considers different approaches for generating an audit information 105. These approaches allow increasing the security level of the resulting vote record 104 and preventing subsequent insertions of bogus votes or any other manipulation made by any of the devices forming the system.

In a first approach, the method considers a solution in which the audit module 103 generates the audit information 105 without carrying out any encoding or, in the event of carrying out any encoding, without using secret (or private) components, such as cryptographic keys. In both cases, this audit information 105 is generated from the digital information containing at least the selected voting options. Taking into account that this step depends on the confirmation 204 of the vote record 104, the confirmation information of said vote record 104 could be additionally used for this generation. Cryptographic algorithms such as summary or hash functions, for example SHA1 or SHA256 functions, can be used to encode the information. It is also considered the use of a cryptographic function, such as a summary accumulation function (OWA), which allows linking different generated audit information in a commutative manner. This last proposal, since generates audit information 105 from the audit information 105 of each of the votes cast regardless of the order in which the votes have been cast, allows carrying out a subsequent audit without compromising the privacy of the voters 106.

In a second approach, and according to a preferred exemplary embodiment of the method proposed in this invention, the audit module 103 generates the audit information 105 by means of an encoding in which at least one secret key is used. As in the previous approach, this encoding can be carried out using the selected voting options, and optionally the confirmation information. In a preferred implementation, said encoding is a digital signature of at least the voting options using the private key of the audit module 103. This measure allows improving the measures of the first approach, because it protects the integrity, the authenticity and the non-repudiation of the audit information 105. For example, it is possible to verify that the digital signature has been effectively carried out by the audit module 103, using the public key of the audit module 103. A symmetrical key can also be used together with a summary function with a key (HMAC). In a less robust implementation, the method can also be implemented with a symmetrical key and a symmetrical encryption algorithm, such as the AES.

For this second approach, the method considers an additional step in which the audit information 105 is sent to the verification module 102, which adds this information to the previously generated vote record 104. Therefore, the vote record 104 is thus provided with the same features as done by the audit module 103, such as for example, integrity, authenticity and non-repudiation. Finally, another additional step considered consists of sending the audit information 105 generated by the audit module 103 to the voting module 101. This information allows the voting module 101 to verify that the generated vote record 104 is correct (e.g. by verifying that the signature is coherent with the one of the selected voting options confirmed). If the voting module 101 electronically stores the confirmed votes, it can also store the audit information 105 for securing the stored electronic vote. This last measure allows verifying the integrity of the votes, assuring that votes that have not been correctly transmitted from the corresponding voting module 101 are not introduced.

In a third approach, also according to a preferred exemplary embodiment of the proposed method, the audit module 103 generates the audit information 105 by means of an encoding in which the voting module 101 is also involved. In this case, for the collaborative generation of the encoded information, each module will have at least its own secret key. As in the previous approach, this encoding can be initially carried out based on at least the selected voting options, with optionally the confirmation information. In this approach, the method considers two possible alternatives for the collaborative encoding of the information.

In a first alternative an additional step is introduced in which audit module 103 begins encoding at least the voting options with its private key and sends this first encoded information to voting module 101. Voting module 101 verifies that this first encoded information received is correct (i.e., verifying the integrity, authenticity and non-repudiation of the encoded information) and generates a second encoded information from at least said first encoded information. Once voting module 101 has generated the second encoded information, a new step is considered in which said second encoded information is sent to audit module 103. Then audit module 103 verifies that this second encoded information received is correct. This alternative is recommended when the confirmation 204 of the vote record 104 is negative (i.e., rejected), using also the confirmation information for generating the encoding.

In a second alternative an additional step is introduced, after the confirmation step 204, in which voting module 101 begins encoding at least the voting options with its private key and sends this first encoded information to audit module 103. Audit module 103 verifies that this first encoded information received is correct and if it is so, it generates a second encoded information from at least said first encoded information. Once the audit module 103 has generated the second encoded information, a new step is considered in which said second encoded information is sent to voting module 101. Then voting module 101 verifies that this second encoded information received is correct. This alternative is recommended when confirmation 204 of the vote record 104 is positive (i.e., accepted).

In both alternatives and in the event that the result of the verification of the encoded information is correct, the method considers that audit module 103 uses the second encoding for the generation 205 of audit information 105. Additionally, if voting module 101 electronically stores the confirmed votes, this second encoded information can be added to the electronic vote to provide security to the electronic vote. The method also considers an additional step of sending the second encoding to the verification module 102 in order to add it to vote record 104.

In a second preferred implementation, it is considered that each module has its own different private asymmetrical key. In this way, the encoding carried out in both modules will be a digital signature, and the verification of the signature will be carried out using the corresponding public key. Therefore, the integrity, authenticity and non-repudiation of audit information 105, electronic vote and/or vote record 104, will be protected by means of a double digital signature. This double digital signature can comprise two independent signatures for the same voting options (and possibly the related confirmation information) combined together, or a nested signature of the voting options.

In a second preferred implementation, the voting module 101 and audit module 103 have fragments of a same private key of the election (or a key associated with each pair composed by a voting module 101 and an audit module 103). Thus each of the modules, in the corresponding step, generates a partial signature. Using a distributed signature protocol based on these partial signatures, it is possible to generate a signature of the election in the same way that would be obtained using directly the private key of the election. Therefore, properties such as integrity, authenticity and non-repudiation of audit information 105, electronic vote and/or vote record 104, are assured by means of verifying this information using the public key of the election associated with the private key.

As described above in the different approaches and alternatives for the generation 205 of the audit information 105 described, the method proposed in the present invention allows the auditing and voting modules to verify that the vote record is being generated correctly. This property allows detecting errors which, without having an audit module 103, would be undetected. An example is the invalidation of votes originally confirmed as valid by voters 106, if an error occurs when generating the digital signature of the vote.

It is possible in the proposed method the addition of more audit modules intercalated among one to another and the voting module 101. This solution would require that the encoding would be done sequentially between one module and the next, allowing each module to verify the encoding of the previous ones. It would be also possible to carry out this encoding in parallel, using any of the distributed signature protocols between the set of audit modules and voting module 101.

The method considers that in all cases in which encoded information is sent to provide the vote record 104 with the corresponding security conditions, this information is adapted to the format of this vote record 104. Thus in the event that said vote record 104 is visual (i.e. printed) the encoded information could be sent in a graphic format (i.e. bar code). In this way, if the vote record is processed automatically, this encoded information could be processed by using the same data collection method (i.e. optical scan). The method also considers that when using more than one verification module 102 connected to the same audit module 103, the encoded information can only be sent to one of the modules.

This invention also considers the possibility of incorporating a unique vote identifier in the vote record 104. This unique vote identifier can be provided by audit module 103 or the voting module 101. To increase the security of the method, in a preferred implementation it is also considered an additional step of the generation of the unique identifier in a cooperative manner between voting the module 101 and audit module 103. The method also preferably considers the use of the unique vote identifier for the generation 205 of audit information 105. In the event that the implementation considers the possibility of storing the electronic votes in the voting module 101 (as has been described above), the use of a unique vote identifier in the electronic vote and the vote record 104 substantially improves the detection of the loss or elimination of votes by means of auditing the election. In this way, if inconsistencies are found in a recount of the vote record and the electronic votes, the unique vote identifier facilitates the finding of the cause of the consistency.

1-50. (canceled)

51. An auditable method for the generation of a verifiable record, such as a voter verifiable vote record, which uses a voting module, a verification module and an audit module, susceptible to different degrees of dispersion and/or clustering using at least a special purpose digital computer, and cryptographic protocols, which enable the generation of said vote record so that assures series of pre-established requirements for an electoral process, said method comprising for each vote, once a voting option/options is/are selected by the voter in said voting module, the following steps:
a) sending from said voting module to said audit module, digital information containing at least said selected voting option/options;
b) sending from said audit module to said verification module at least said voting option/options contained in said digital information received in step a) by said audit module, for the generation by said verification module of said vote record verifiable by the voter which contains at least said voting option/options;
c) confirming, by action or omission, the coincidence or non-coincidence of the voting intention of the voter within said voting option/options contained in said verifiable vote record (104); and
d) generating by at least said audit module of at least one digital audit information to assure in a later audit the validity of the votes cast.

52. A method according to claim 51, further comprising providing a verification of said vote record by visual and/or audible means using one or more verification modules.

53. A method according to claim 51, wherein said confirmation specified in step c) is carried out in said audit module by the voter.

54. A method according to claim 51, further comprising:
generating a digital confirmation information containing at least the result of said confirmation by means of said audit module, and
transmitting said digital confirmation information from said audit module to said voting module.

55. A method according to claim 51, wherein in the event that said confirmation indicates the non-coincidence of the intention of the voter with said voting option/options contained in said verifiable vote record, said audit module sends digital information containing at least one indication of said non-coincidence to said verification module which optionally adds a record indicating said non-coincidence in said verifiable vote record generated in step b).

56. A method according to claim 51, wherein the voting module additionally associates a unique vote identifier to each vote and/or wherein the audit module additionally associates a unique vote identifier to the digital information containing the voting options received in step a), being this unique vote identifier generated individually or collaboratively by one or both voting module and audit module.

57. A method according to claim 51, wherein the audit module generates said digital audit information specified in step d) from at least said voting option/options.

58. A method according to claim 57, wherein at least one encoding is carried out to generate said digital audit information for which said audit module is provided with at least one symmetric or asymmetric key.

59. A method according to claim 58, further comprising sending to said voting module at least part of said encoding carried out by said audit module which optionally stores a copy of at least part of said digital information of step a) and/or part of said encoding received from said audit module.

60. A method according to claim 57, wherein said audit module electronically stores a copy of at least part of said digital information of step a) and/or part of said encoding carried out by said audit module.

61. A method according to claim 58, further comprising sending to said verification module at least part of said encoding carried out by said audit module and/or adding in said verifiable vote record generated in step b) a record containing at least part of said encoding received from said audit module.

62. A method according to claim 61, further comprising encoding in said voting module at least said voting options and sending from said voting module to said audit module at least part of said encoding.

63. A method according to claim 62, further comprising carrying out, by means of said audit module, a second encoding from at least said voting option/options and/or at least said encoding received from said voting module, providing for generating both encodings at least one symmetric or asymmetric key for the voting module and another to the audit module, being these keys different ones, the same key or the shares of a same key.

64. A method according to claim 63, wherein said digital audit information of step d) is generated at least from said encoding received from said voting module and/or said second encoding.

65. A method according to claim 64, further comprising sending to said voting module at least part of said second encoding carried out by said audit module which optionally electronically stores a copy of at least part of said digital information of step a) and/or part of said second encoding received from said audit module.

66. A method according to claim 65, wherein said audit module electronically stores a copy of at least part of said digital information of step a) and/or part of said second encoding carried out by said audit module.

67. A method according to claim 66, wherein said electronic copy is stored in a position inside a storage area that does not enable correlating the order of emission of the votes with their storage order.

68. A method according to claim 63, further comprising sending to said verification module at least part of said second encoding carried out by said audit module and optionally adding in said verifiable vote record generated in step b) a record comprising at least part of said second encoding received from said audit module.

69. An auditable electronic voting system generating a vote record verifiable by a voter for implementing the method described in claim 51, comprising:
a voting module configured to show voting options and to record a selection/selections of said voting option/options, comprising:
i) processing means;
ii) means of displaying at least one/several voting option/options;
iii) data entry means which enable the voter to select voting option/options; and
iv) data input and output means for transmitting at least digital information containing at least said selected voting option/options; and
a verification module comprising at least data input and output means for receiving at least said selected voting option/options and generating a vote record of at least said voting option/options received, said record being verifiable by the voter,
audit module intercalated between said voting module and said verification module, and adapted to receive digital information from at least said voting module, and to generate digital audit information comprising:
i) processing means; and
ii) data input and output means for receiving at least said digital information from said voting module.

70. A system according to claim 69, characterized in that said verification module is a printer or an audio device, chosen from the group comprising at least headphones or loudspeakers.

71. A system according to claim 69, characterized in that said audit module and said verification module, which is at least one in number, share said data input and output means of said audit module.

72. A system according to claim 69, characterized in that said audit module also comprises storage means for storing at least part of the information received through said data input means from said voting module, at least one key for generating encoding information using the audit module processing means and/or at least part of digital information encoded by said processing means.

73. A system according to claim 72, characterized in that part of said processing means and part of said storage means are located in a removable device such as a smart card.

74. A system according to claim 69, characterized in that said audit module comprises confirmation means from the group that comprises at least a button or a microphone.
